(19) United States
(12) Patent Application Publication
(10) Pub. No.: US 2015/0037226 A1
(43) Pub. Date: Feb. 5, 2015

(54) MICROFLUIDIC DEVICE AND METHOD OF PRODUCING THE SAME

(71) Applicant: SAMSUNG ELECTRONICS CO., LTD., Suwon-si (KR)

(72) Inventors: Jung Ki MIN, Yongin-si (KR); Seung Hoon KIM, Suwon-si (KR); Seung Jun LEE, Yongin-si (KR)

(73) Assignee: SAMSUNG ELECTRONICS CO., LTD., Suwon-si (KR)

(21) Appl. No.: 14/449,595

(22) Filed: Aug. 1, 2014

(30) Foreign Application Priority Data
Aug. 2, 2013 (KR) 10-2013-0092260

(51) Int. Cl. B01L 3/00; B32B 38/00; B32B 37/12; B32B 37/18

(52) U.S. Cl. CPC B01L 3/502707; B01L 3/502723; B01L 3/50273; B01L 3/502715; B32B 37/18; B32B 38/0004; B32B 37/12; B01L 2300/161; B01L 2300/0864; B01L 2300/0803; B01L 2400/0409; B32B 2037/1246; B32B 2305/026; B32B 2305/022; B32B 2307/73
USPC 422/502; 156/292; 156/257

(57) ABSTRACT

A microfluidic device and a method of producing the microfluidic device are provided. The microfluidic device includes an upper substrate and a lower substrate fixed to each other to form a microfluidic structure, and a hydrophobic porous layer disposed between the upper substrate and the lower substrate, and configured to fix the upper and lower substrates and absorb air within the microfluidic structure.

### CROSS-REFERENCE TO RELATED APPLICATION

This application claims priority from Korean Patent Application No. 10-2013-92260, filed on Aug. 2, 2013 in the Korean Intellectual Property Office, the disclosure of which is incorporated herein by reference.

### BACKGROUND

1. Field

Apparatuses and methods consistent with exemplary embodiments relate to a microfluidic device used for testing a sample and a method of producing the same.

2. Description of the Related Art

In recent years, techniques related to a test device using microfluidic structures have been developed to analyze samples such as small amounts of blood or urine and diagnose a patient's illness by detecting the presence or absence of a specific element.

A test device using microfluidic structures is referred to as a microfluidic device. The microfluidic structures, for example, a plurality of chambers configured to contain a sample or a reagent and a channel configured to connect the plurality of chambers, may be prepared in the microfluidic device.

In the related art, a vent configured to communicate with the outside may be formed in a chamber or a channel in order to smoothly move a sample or a reagent within a microfluidic structure so that the air contained in the microfluidic structure can be exhausted. Accordingly, a large space of a small-sized microfluidic device in which microfluidic structures are integrated may be occupied by the vent, and a degree of freedom for design may be limited.

In addition, when a microfluidic device that has finished a test is not discarded, residues contained in the microfluidic device may leak through the vent due to a capillary phenomenon and cause sanitary problems. When an infectious sample is tested, infections may occur.

### SUMMARY

Exemplary embodiments provide a microfluidic device, in which a porous membrane is disposed in a partition wall of a microfluidic structure so that the air within the microfluidic structure can be exhausted to enable smooth movement of a fluid, and a method of producing the microfluidic device.

In accordance with an aspect of an exemplary embodiment, there is provided a microfluidic device including an upper substrate and a lower substrate fixed to each other to form a microfluidic structure, and a hydrophobic porous layer disposed between the upper substrate and the lower substrate and configured to fix the upper and lower substrates and absorb air contained in the microfluidic structure.

The hydrophobic porous layer may include a hydrophobic porous membrane, an upper adhesive layer disposed on a top surface of the hydrophobic porous membrane and configured to adhere the hydrophobic porous membrane to the upper substrate, and a lower adhesive layer disposed on a bottom surface of the hydrophobic porous membrane and configured to adhere the hydrophobic porous membrane to the lower substrate.

The hydrophobic porous layer may be a hydrophobic porous adhesive layer.

The hydrophobic porous membrane may be a porous membrane subjected to hydrophobic processing.

The hydrophobic porous adhesive layer may include a porous adhesive subjected to hydrophobic processing.

The hydrophobic porous adhesive layer may be a foam tape.

The porous membrane may include at least one material selected from the group consisting of polycarbonate (PC), polyether sulfone (PES), polyethylene (PE), polysulfone (PS), polyaryl sulfone (PASF), polyethylene naphthalate (PEN), polyimide (PI), and cellulose acetate (CA).

The porous membrane may have a pore size of about 0.3 μm to about 50 μm.

The porous membrane may be coated with a silicon (Si)-based, fluorine (F)-based, or Si—F compound-based oligomer or polymer.

The hydrophobic porous membrane may have a contact angle of about 90° to about 170°.

In accordance with an aspect of another exemplary embodiment, there is provided a method of producing a microfluidic device, the method including preparing an upper substrate and a lower substrate, preparing a hydrophobic porous layer configured to absorb air contained in the microfluidic structure, and fixing the upper substrate and the lower substrate via the hydrophobic porous layer to form a microfluidic structure.

The hydrophobic porous layer may include a hydrophobic porous membrane, an upper adhesive layer disposed on a top surface of the hydrophobic porous membrane and configured to adhere the hydrophobic porous membrane to the upper substrate, and a lower adhesive layer disposed on a bottom surface of the hydrophobic porous membrane and configured to adhere the hydrophobic porous membrane to the lower substrate.

The hydrophobic porous layer may be a hydrophobic porous adhesive layer.

The preparing the hydrophobic porous layer may include subjecting the porous membrane to hydrophobic processing.

The preparing the hydrophobic porous layer may include subjecting the porous adhesive layer to hydrophobic processing.

The hydrophobic porous layer may be a foam tape.

The method may further include engraving an engraving structure corresponding to the microfluidic structure in at least one of the upper substrate and the lower substrate.

The method may further include removing a portion corresponding to the microfluidic structure from the hydrophobic porous layer.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a plan view of a related art microfluidic device having a vent;

FIG. 2 is a plan view of a microfluidic device in accordance with an exemplary embodiment;

FIG. 3 illustrates a cross-sectional view of one portion of a platform of a microfluidic device in accordance with an exemplary embodiment and an exploded perspective view of substrates corresponding to the cross-sectional view;

FIG. 4 illustrates a cross-sectional view of one portion of a platform of a microfluidic device in accordance with another exemplary embodiment and an exploded perspective view of substrates corresponding to the cross-sectional view;

FIG. 5 illustrates a cross-sectional view of one portion of a platform of a microfluidic device in accordance with another exemplary embodiment and an exploded view of substrates corresponding to the cross-sectional view;

FIG. 6 illustrates a cross-sectional view of one portion of a platform of a microfluidic device in accordance with another exemplary embodiment and an exploded view of substrates corresponding to the cross-sectional view;

FIG. 7 illustrates a cross-sectional view of one portion of a platform of a microfluidic device in accordance with another exemplary embodiment and an exploded view of substrates corresponding to the cross-sectional view;

FIG. 8 illustrates a cross-sectional view of one portion of a platform of a microfluidic device in accordance with another exemplary embodiment and an exploded view of substrates corresponding to the cross-sectional view;

FIG. 9 is a view illustrating the outer appearance of a test device configured to perform a test using a microfluidic device in accordance with an exemplary embodiment; and

FIG. 10 is a flowchart illustrating a method of producing a microfluidic device in accordance with an exemplary embodiment.

### DETAILED DESCRIPTION

Reference will now be made in detail to exemplary embodiments, examples of which are illustrated in the accompanying drawings, wherein like reference numerals refer to like elements throughout.

Hereinafter, a microfluidic device and a method of producing the same according to an exemplary aspect will be described more fully with reference to the accompanying drawings, in which exemplary embodiments are shown.

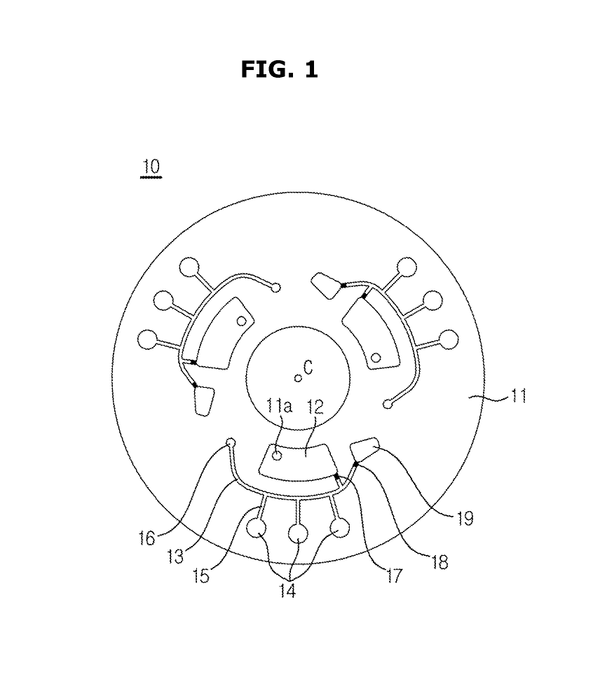

FIG. 1 is a plan view of a related art microfluidic device 10 in which a vent 16 is formed.

Referring to FIG. 1, the microfluidic device 10 may include a platform 11 having a rotatable shape and microfluidic structures formed in the platform 11. Each of the microfluidic structures may include a plurality of chambers configured to contain a material, such as a sample or a reagent, and a channel configured to connect the chambers.

In an example of FIG. 1, microfluidic structures, for example, an injection port 11a configured to receive an injected sample, a sample supply chamber 12 configured to contain the sample injected through the injection port 11a and supply the sample into other chambers, a reagent chamber 19 configured to contain the reagent, a plurality of reaction chambers 14 within which a reaction between the reagent and the sample occurs, a distribution channel 13 configured to distribute the sample contained in the sample supply chamber 12 into the plurality of reaction chambers 14, branch channels 15 branched from the distribution channel 13 into the respective reaction chambers 14, and valves 17 and 18 prepared at outlets of the sample supply chamber 12 and the reagent chamber 19, may be formed in the platform 11.

When the valve 17 is opened and the platform 11 is rotated in order to supply the sample contained in the sample supply chamber 12 into the reaction chambers 14, the sample may move along the distribution channel 13. In this case, since the distribution channel 13 is filled with the air injected along with the sample, when the air is not exhausted from the distribution channel 13, the sample may not move smoothly.

Accordingly, the vent 16 may be formed at an end portion of the distribution channel 13 so that the air can be exhausted from the distribution channel 13. Since the sample moves due to centrifugal force, the sample may move in a direction away from an outer circumferential direction of the platform 11, that is, away from a rotational center C. Accordingly, the vent 16 may be formed in a position closer to the rotational center C than to a water level of a fluid, such as the sample or the reagent.

Although FIG. 1 illustrates an example in which microfluidic structures are simplified, a small-sized microfluidic device in which a large number of microfluidic structures are integrated may include a vent 16 formed at an inner circumferential portion having a small area so that a degree of freedom of design can be limited.

In addition, when an infectious sample is tested and a reaction residue flows out through the vent 16 of the undiscarded microfluidic device 10, users or other persons that may be in contact with the microfluidic device 10 may be vulnerable to infection.

Accordingly, one or more exemplary embodiments provide a microfluidic device capable of exhausting air from microstructures, such as channels or chambers, without requiring a vent. Hereinafter, various exemplary embodiments of a microfluidic device will be described.

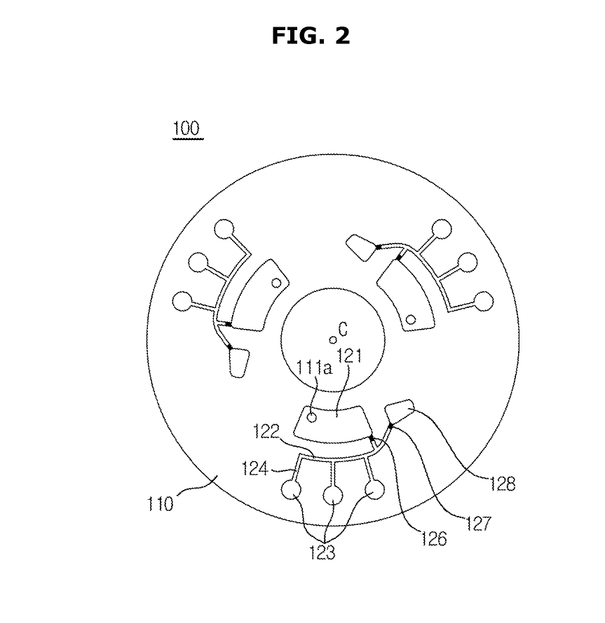

FIG. 2 is a plan view of a microfluidic device in accordance with an exemplary embodiment.

Although microfluidic structures are formed in the microfluidic device 100, assuming in the present exemplary embodiment that the microfluidic device 100 is formed of a transparent material, the microfluidic structures formed in the microfluidic device 100 may be seen from a top view as shown in FIG. 2.

The microfluidic device 100 may include a platform 110 and microfluidic structures formed on the platform 110.

The platform 110 may be formed of any material that is easily moldable and has a biologically inactive surface. Thus, the platform 110 may be formed of various materials such as but not limited to, for example, a plastic material, such as an acryl (e.g., polymethyl methacrylate (PMMA)), polydimethyl siloxane (PDMS), polycarbonate (PC), polypropylene (PP), polyvinyl alcohol (PVA), or polyethylene (PE), glass, mica, silica, or a silicon wafer.

The above-described materials are only examples of materials that may be used as materials forming an upper substrate and a lower substrate that will be described later. Thus, the platform 110 may be formed of any material having chemical and biological stability and mechanical processibility. When optical analysis is utilized to obtain test results from the microfluidic device 100, the platform 110 may be formed of a material having high optical transparency.

Centrifugal force generated during rotation of the microfluidic device 100 may be used to move materials within a microfluidic structure. Although FIG. 2 illustrates a disk-type platform 110 having a circular plate shape, the platform 110 described herein may be formed to have a rotatable fan shape, or a polygonal shape so long as the platform 110 is capable of being rotated.

In various embodiments, the term “microfluidic structure” may not only refer to a structure having a specific shape, but may inclusively refer even to materials capable of serving specific functions as needed. Microfluidic structures may therefore implement different functions according to disposition characteristics or the kind of material contained therein.

Although various microfluidic structures may be formed in the microfluidic device 100 according to the kind and purpose of the test and/or the number of tests to be performed, for ease of explanation, it will be assumed that microfluidic structures c shown in FIG. 1 are formed in the present exemplary embodiment.

Referring to FIG. 2, microfluidic structures, for example, an injection port 111a configured to receive an injected sample, a sample supply chamber 121 configured to contain the sample injected through the injection port 111a and supply the sample into other chambers, a reagent chamber 128 configured to contain a reagent, a plurality of reaction chambers 123 within which a reaction between the reagent and the sample occurs, a distribution channel 122 configured to distribute the sample contained in the sample supply chamber 121 into the plurality of reaction chambers 123, branch channels 124 branched from the distribution channel 122 into the respective reaction chambers 123, and valves 126 and 127 prepared at outlets of the sample supply chamber 121 and the reagent chamber 128, may be formed in the platform 110 of the microfluidic device 100.

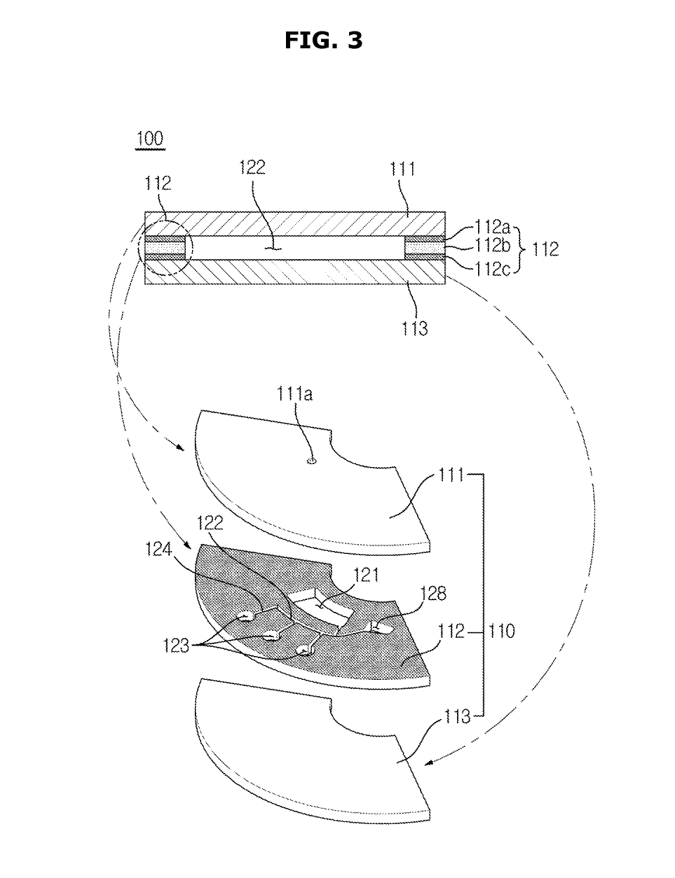

When the valve 126 is opened and the platform 110 is rotated, the sample may flow from the sample supply chamber 121 to the reaction chambers 123 through the distribution channel 122. Although a vent 16 is not formed in the platform 110 as shown in FIG. 2, the air contained in the distribution channel 122 may be exhausted from the distribution channel 122 so that the sample can move smoothly. To this end, the platform 110 may have a structure as shown in FIG. 3.

FIG. 3 illustrates a cross-sectional view of one portion of a platform 110 of a microfluidic device in accordance with an exemplar embodiment and an exploded perspective view of substrates corresponding to the cross-sectional view. Here, the cross-sectional view of FIG. 3 is obtained by cutting the distribution channel 122 in a direction in which the sample or the reagent moves.

As shown in FIG. 3, the platform 110 may include an upper substrate 111, a lower substrate 113, and a middle layer 112 disposed between the upper substrate 111 and the lower substrate 113.

A microfluidic structure may be formed in the platform 110 using a method of engraving the microfluidic structure in an upper substrate or a lower substrate or a method of excavating a portion corresponding to the microfluidic structure in the middle layer 112 and covering top and bottom surfaces of the portion with the upper substrate 111 and the lower substrate 113. In the present exemplary embodiment, it is assumed that the latter method is used. Accordingly, portions corresponding to chambers 121, 123, and 128 or channels 122 and 124 may be removed from the middle layer 112, and the thickness of the middle layer 112 may be appropriately adjusted according to the size of the chamber or channel.

The upper substrate 111 and the lower substrate 113 may be fixed to top and bottom surfaces of the middle layer 112 to form a closed space. However, the injection port 111a configured to receive an injected sample from the outside may be formed in the upper substrate 111.

As shown in FIGS. 2 and 3, although the vent 16 is not formed in the platform 110 of the microfluidic device 100, the air contained in the distribution channel 122 may be exhausted from the distribution channel 122, and the air contained in the sample supply chamber 121, the reagent chamber 128, or the reaction chambers 123 may also be exhausted from the chambers.

To this end, the middle layer 112 may be formed from a porous material. When the middle layer 112 is embodied by the porous layer, the air contained in the chambers or the channel may be absorbed by the porous layer and exhausted from the chambers or the channel. Accordingly, the sample or the reagent may move smoothly without a vent.

As shown in FIG. 3, the porous layer 112 may include a porous membrane 112b, an upper adhesive layer 112a disposed on the porous membrane 112b and configured to adhere the porous membrane 112b to the upper substrate 111, and a lower adhesive layer 112c disposed under the porous membrane 112b and configured to adhere the porous membrane 112b to the lower substrate 113. Thus, the upper adhesive layer 112a and the lower adhesive layer 112c may have a double-sided adhesive property and adhere the porous layer 112 to the upper substrate 111 and the lower substrate 113, respectively.

The porous membrane 112b may have a pore size of about 0.3 μm to about 50 μm.

Also, the porous membrane 112b may have a hydrophobic property. Accordingly, a liquid, such as the sample or the reagent, may not be absorbed in the porous layer 112 but may flow along normal paths (i.e., the channels 122 and 124).

The hydrophobic porous membrane 112b may be formed of a hydrophobic material, a hydrophobic-processed hydrophilic material, or a hydrophobic-processed weak-hydrophobic material.

In a specific example, the porous membrane 112b may be formed from a hydrophobic material, such as polyvinylidene difluoride (PVDF) or polytetra fluoroethylene (PTFE).

Alternatively, a porous membrane formed of a hydrophilic material or a weak-hydrophobic material may be subject to hydrophobic processing such as being coated with a silicon (Si)-based, fluorine (F)-based, or Si—F compound-based oligomer or polymer, or plasma.

When the porous membrane 112b is hydrophobic-processed, a material, such as polycarbonate (PC), polyether sulfone (PES), polyethylene (PE), polysulfone (PS), polyaryl sulfone (PASF), polyethylene naphthalate (PEN), polyimide (PI), or cellulose acetate (CA), may be manufactured to be porous and subjected to hydrophobic-processing.

The hydrophobic porous layer 112 may have a contact angle of about 90° to about 170°. The contact angle refers to an angle formed by a surface of a horizontal solid with a surface of a liquid when the liquid is put on a surface of the horizontal solid and maintains a droplet having a constant lens shape. Thus, when the contact angle is greater than about 90°, it can be inferred that the liquid maintains a droplet shape on the surface of the solid without wetting the surface of the solid.

Materials forming the hydrophobic porous layer 112 according to the exemplary embodiment or methods of processing the hydrophobic porous layer 112 are not limited to the above-described examples. The porous layer 112 may be formed of any material having a hydrophobic property and porosity.

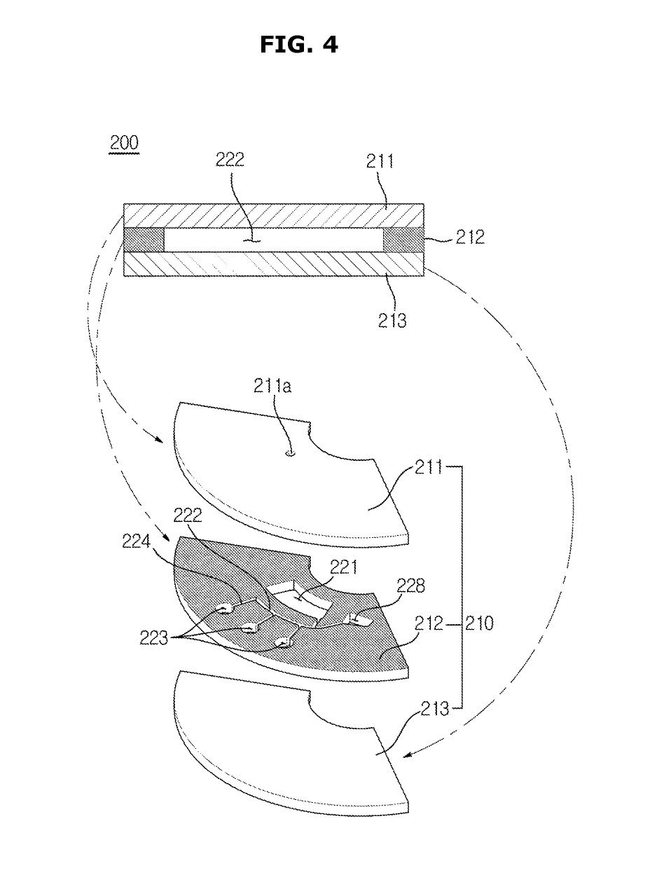

FIG. 4 illustrates a cross-sectional view of one portion of a platform 210 of a microfluidic device 200 in accordance with another exemplar embodiment and an exploded perspective view of substrates corresponding to the cross-sectional view. Here, the cross-sectional view of FIG. 4 is obtained by cutting a distribution channel 222 in a direction in which a sample or a reagent moves.

Similar to the platform 110 of the previous exemplary embodiment, the platform 210 of the microfluidic device 200 in accordance with another exemplary embodiment may include an upper substrate 211, a lower substrate 213, and a middle layer 212 disposed between the upper and lower substrates 211 and 213. Also, a description of an injection port 211a, a sample supply chamber 221, a reagent chamber 228, the distribution channel 222, a branch channel 224, and reaction chambers 223 may be the same as in the previous exemplary embodiment.

The middle layer 212 may be embodied by a phosphoric porous layer. The middle layer 212 may have a double-sided adhesive property and therefore function as double-sided tape. Accordingly, an additional adhesive layer may not be needed in addition to the phosphoric porous layer 212. The phosphoric porous layer 212 may be disposed between the upper substrate 211 and the lower substrate 213 and fix (i.e., adhere) the upper substrate 211 and the lower substrate 213 to each other.

Thus, the hydrophobic porous layer 212 may be embodied by a foam tape.

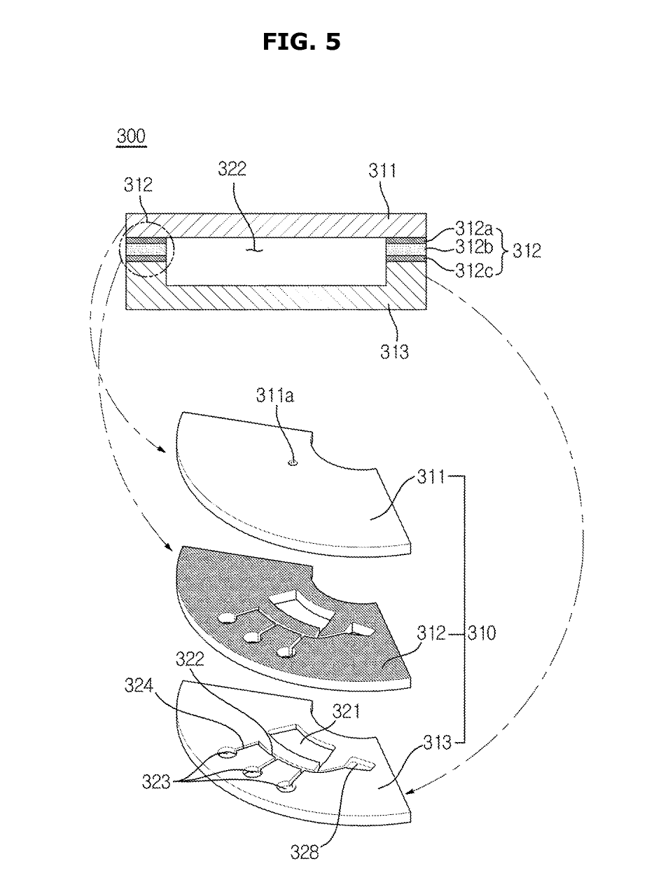

FIG. 5 illustrates a cross-sectional view of one portion of a platform 310 of a microfluidic device 300 in accordance with another exemplary embodiment and an exploded view of substrates corresponding to the cross-sectional view. Here, the cross-sectional view of FIG. 5 is obtained by cutting a distribution channel 322 in a direction in which a sample or a reagent moves.

The platform 310 of the microfluidic device 300 in accordance with another exemplary embodiment may include an upper substrate 311, a lower substrate 313, and a middle layer 312 disposed between the upper substrate 311 and the lower substrate 313.

In the previously described exemplary embodiments, portions corresponding to microfluidic structures may be removed from the middle layers 112 and 212, and the upper substrates 111 and 211 and the lower substrates 113 and 213 may cover the tops and bottoms of the middle layers 112 and 212 to form closed spaces. However, in the microfluidic device 300 according to the present exemplary embodiment, an engraving structure corresponding to a microfluidic structure may be engraved in a top surface of the lower substrate 313 (i.e., a surface of the lower substrate 313 that faces the upper substrate 311), and the lower substrate 313 may be covered with the upper substrate 311 to complete a closed structure. Here, since the portion of the lower substrate 313 corresponding to the microfluidic structure is not completely removed, a bottom surface of the lower substrate 313 may serve as the bottom surface of the microfluidic device 300.

In addition, a hydrophobic porous layer 312 may be disposed between the upper substrate 311 and the lower substrate 313 and fix the upper substrate 311 and the lower substrate 313. When necessary, only a portion of the hydrophobic porous layer 312 corresponding to the microfluidic portion may be removed, as shown in FIG. 5. However, the exemplary embodiment is not limited thereto and may provide any structure in which the circumference of a region corresponding to the microstructure is surrounded with the hydrophobic porous layer 312.

The hydrophobic porous layer 312 corresponding to a middle layer may include a hydrophobic porous membrane 312b and an upper adhesive layer 312a and a lower adhesive layer 312c disposed above and below the hydrophobic porous membrane 312b and configured to adhere the hydrophobic porous membrane 312b to the upper substrate 311 and the lower substrate 313, respectively.

The adhesive layers 312a and 312c and the hydrophobic porous membrane 312b may be the same as the adhesive layers 112a and 112c and the hydrophobic porous membrane 112b described in the exemplary embodiment of FIG. 3.

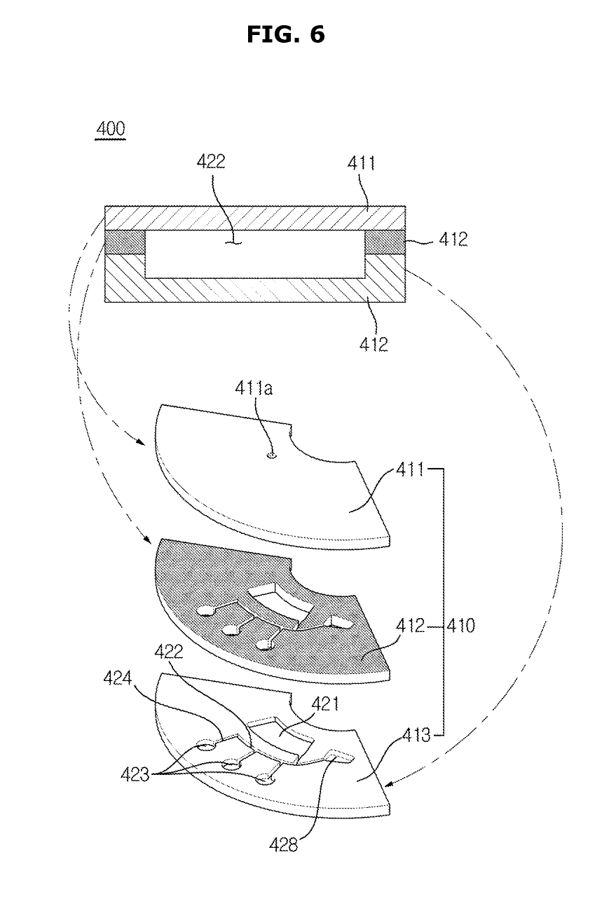

FIG. 6 illustrates a cross-sectional view of one portion of the platform 410 of the microfluidic device in accordance with another exemplary embodiment and an exploded view of substrates corresponding to the cross-sectional view. Here, the cross-sectional view of FIG. 6 is obtained by cutting a distribution channel 422 in a direction in which a sample or a reagent moves.

Referring to FIG. 6, as in the embodiment of FIG. 5, the platform 410 of the microfluidic device 400 may include an upper substrate 411, a lower substrate 413 on which a structure corresponding to a microfluidic structure is engraved, and a hydrophobic porous layer 412 disposed between the upper substrate 411 and the lower substrate 413.

In addition, a description of an injection port 411a, a sample supply chamber 421, a reagent chamber 428, a distribution channel 422, a branch channel 424, and reaction chambers 423 formed in the platform 410 may be the same as in the previous exemplary embodiment.

As described above, the hydrophobic porous layer 412 may exhibit an adhesive property and function as a tape. Accordingly, an additional adhesive layer may not be needed in addition to the hydrophobic porous layer 412. The hydrophobic porous layer 412 may be disposed between the upper substrate 411 and the lower substrate 413 and fix (i.e., adhere) the upper substrate 411 and the lower substrate 413 to each other.

Thus, the hydrophobic porous layer 412 may be embodied by a foam tape.

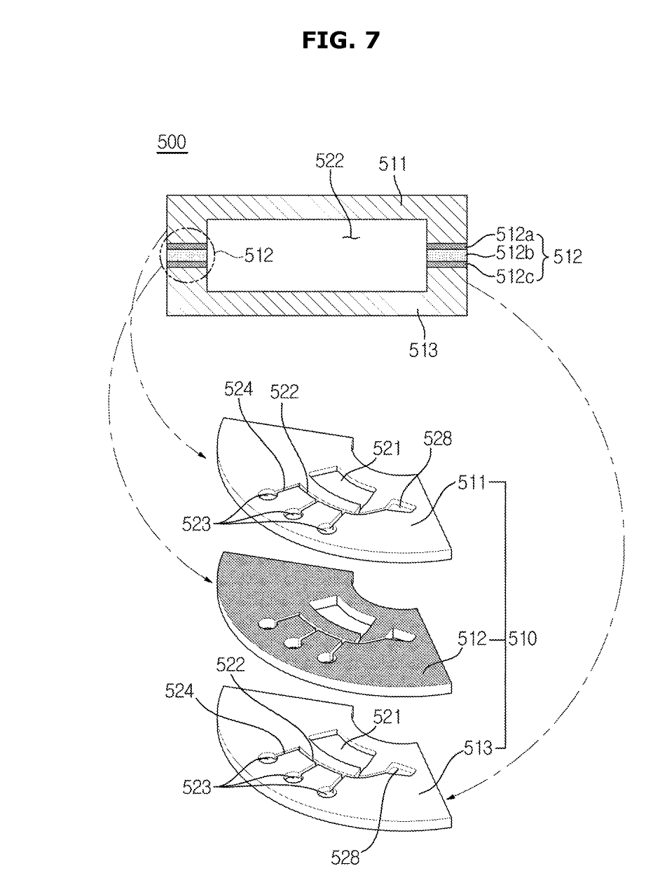

FIG. 7 illustrates a cross-sectional view of one portion of a platform 510 of a microfluidic device 500 in accordance with another exemplary embodiment and an exploded view of substrates corresponding to the cross-sectional view. Here, the cross-sectional view of FIG. 7 is obtained by cutting a distribution channel 522 in which a sample or a reagent moves.

Referring to FIG. 7, the platform 510 of the microfluidic device 500 according to the present exemplary embodiment may include an upper substrate 511, a lower substrate 513, and a hydrophobic porous layer 512 disposed between the upper substrate 511 and the lower substrate 513.

The exemplary embodiments of FIGS. 5 and 6 describe that engraving structures corresponding to microfluidic structures are engraved in the lower substrates 313 and 413. However, in the microfluidic device 500 according to the present exemplary embodiment, engraving structures corresponding to a microfluidic structure may be engraved in surfaces of the upper and lower substrates 511 and 513 that face each other, and the upper and lower substrates 511 and 513 may be vertically fixed to each other by the hydrophobic porous layer 512 to complete the microfluidic structure.

Since portions of the upper and lower substrates 511 and 513 corresponding to the microfluidic structure are not completely removed, a top surface of the upper substrate 511 and a bottom surface of the lower substrate 513 may serve as the top and bottom surfaces of the microfluidic device 500. However, it is assumed for ease of explanation that the upper substrate 511 is formed of a transparent material.

Although only a portion of the hydrophobic porous layer 512 corresponding to the microfluidic structure may be removed as shown in FIG. 7, the exemplary embodiment is not limited thereto and may provide any structure in which the circumference of a region corresponding to the microfluidic structure is surrounded with the hydrophobic porous layer 512.

The hydrophobic porous layer 512 may include a hydrophobic porous membrane 512b with an upper adhesive layer 512a and a lower adhesive layer 512c disposed above and below the hydrophobic porous membrane 512b, and configured to adhere the hydrophobic porous membrane 512b to the upper substrate 511 and the lower substrate 513, respectively.

The adhesive layers 512a and 512c and the hydrophobic porous membrane 512b may be the same as the adhesive layers 112a and 112c and the hydrophobic porous membrane 112b described in the exemplary embodiment of FIG. 3.

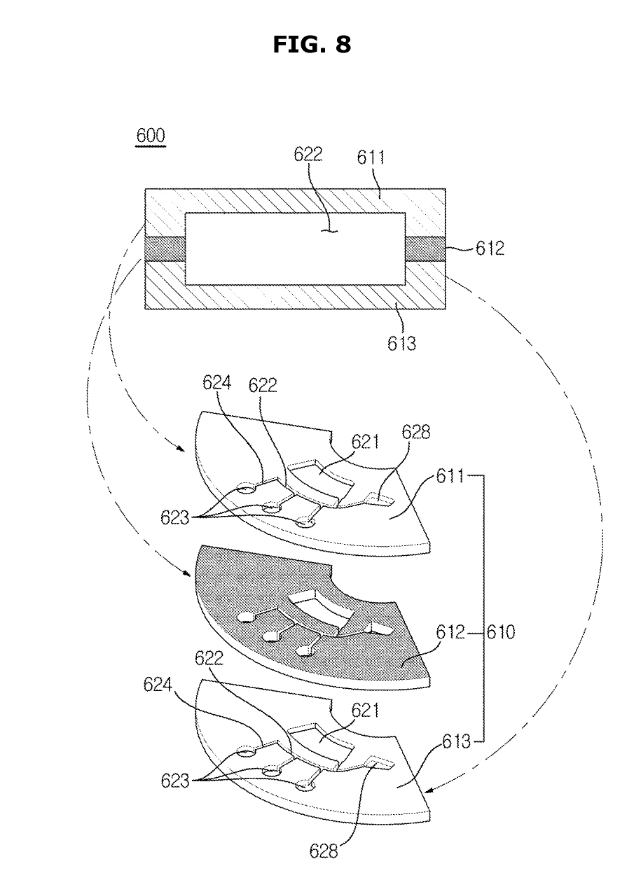

FIG. 8 illustrates a cross-sectional view of one portion of a platform of a microfluidic device in accordance with another exemplary embodiment and an exploded view of substrates corresponding to the cross-sectional view. Here, the cross-sectional view of FIG. 8 is obtained by cutting a distribution channel 622 in a direction in which a sample or a reagent moves.

Referring to FIG. 8, similar to the exemplary embodiment of FIG. 7, a platform 610 of a microfluidic device 600 according to the present exemplary embodiment may include an upper substrate 611 and a lower substrate 613 in which a structure corresponding to a microfluidic structure is engraved, and a hydrophobic porous layer 612 disposed between the upper and lower substrates 611 and 613.

In addition, a description of an injection port 611a, a sample supply chamber 621, a reagent chamber 628, a distribution channel 622, a branch channel 624, and reaction chambers 623 may be the same as in the previous exemplary embodiments.

As described above, the hydrophobic porous layer 612 may have an adhesive property and function as an adhesive tape. Accordingly, an additional adhesive layer may not be needed in addition to the hydrophobic porous layer 612. The hydrophobic porous layer 612 may be disposed between the upper substrate 611 and the lower substrate 613 and fix (i.e., adhere) the upper substrate 611 and the lower substrate 613 to each other.

The hydrophobic porous layer 612 may be embodied by a foam tape.

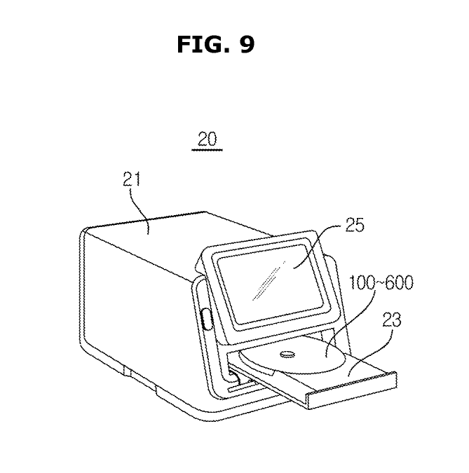

FIG. 9 is a view illustrating the outer appearance of a test device configured to perform a test using a microfluidic device in accordance with an exemplary embodiment.

Microfluidic devices 100, 200, 300, 400, 500, and 600 (hereinafter referred to as 100 to 600) into which a sample is injected through injection ports 111a, 211a, 311a, 411a, 511a, and 611a may be put on a tray 23 of the test device 20, and the tray 23 may be inserted into a main body 21 of the test device 20. In this case, the test device 20 may rotate the microfluidic devices 100 to 600 and perform tests.

During the rotation of the microfluidic devices 100 to 600, the sample or the reagent may move due to centrifugal force, and a hydrophobic porous layer included in a platform of each of the microfluidic devices 100 to 600 may absorb the air contained in microfluidic structures, such as chambers or channels so that a sample or a reagent can move smoothly without the need for a vent.

When a test is completed, test results may be displayed on the display unit 25. Thus, even if the microfluidic devices 100 to 600 that have been tested are not discarded, reaction fluids may not leak out.

Hereinafter, an exemplary embodiment of a method of producing a microfluidic device according to an exemplary aspect will be described.

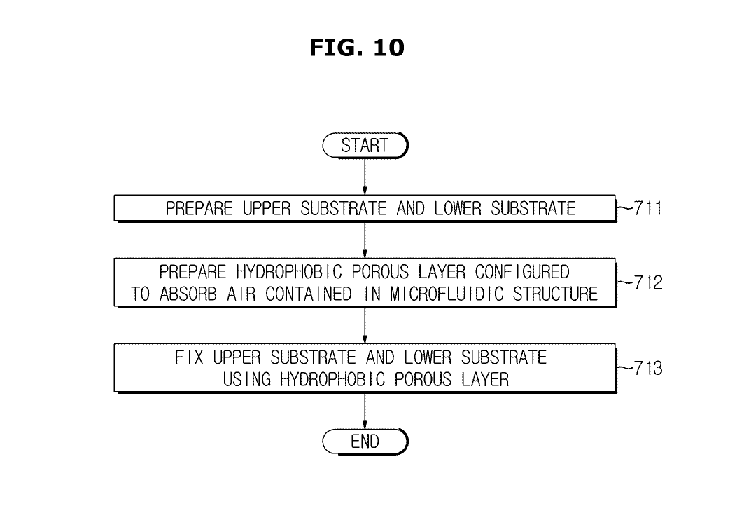

FIG. 10 is a flowchart illustrating a method of producing a microfluidic device in accordance with an exemplary embodiment.

Referring to FIG. 10, an upper substrate and a lower substrate may be prepared (operation 711). Here, the upper substrate and the lower substrate may be included in a platform of the microfluidic device and formed of a material that may be molded and have a biologically inactive surface. A structure corresponding to a microfluidic structure, such as a chamber and/or a channel, may be engraved in at least one of the upper and lower substrates, and an injection port configured to receive an injected sample may be engraved only in the upper substrate.

A hydrophobic porous layer configured to absorb the air contained in the microfluidic structure may be prepared (operation 712). The hydrophobic porous layer may be formed by adhering an upper adhesive layer to a top surface of a hydrophobic porous membrane and adhering a lower adhesive layer to a bottom surface of the hydrophobic porous membrane. Each of the upper adhesive layer and the lower adhesive layer may have a double-sided adhesive property.

The hydrophobic porous membrane may be prepared using a material having a hydrophobic property or prepared by subjecting a hydrophilic material or a weak-hydrophobic material to hydrophobic processing.

In a specific example, the porous membrane may be formed from a hydrophobic material, such as polyvinylidene difluoride (PVDF) or polytetra fluoroethylene (PTFE).

Alternatively, to perform hydrophobic-processing, a porous membrane formed of a hydrophilic material or a weak-hydrophobic material may be coated with a silicon (Si)-based, fluorine (F)-based, or Si—F compound-based oligomer or polymer, or plasma may be used.

When the porous membrane is subjected to hydrophobic-processing, a material, such as polycarbonate (PC), polyether sulfone (PES), polyethylene (PE), polysulfone (PS), polyaryl sulfone (PASF), polyethylene naphthalate (PEN), polyimide (PI), and cellulose acetate (CA), may be manufactured to be porous and subjected to the hydrophobic-processing.

The hydrophobic porous layer may have a contact angle of about 90° to about 170°.

Alternatively, the hydrophobic porous layer may be produced using a double-sided adhesive material and used without an additional adhesive layer. In this case, the hydrophobic porous layer may be a foam tape.

Since a portion of the hydrophobic porous layer corresponding to a microstructure may be removed, the removed portion of the hydrophobic porous layer may serve as a microfluidic structure without the need for engraving the upper and lower substrates.

The upper substrate and the lower substrate may be fixed using the hydrophobic porous layer (operation 713). That is, the hydrophobic porous layer may be disposed between the upper substrate and the lower substrate. Since an upper adhesive layer and a lower adhesive layer are adhered to top and bottom surfaces of the hydrophobic porous layer or the hydrophobic porous layer exhibits a double-sided adhesive property, the upper substrate and the lower substrate may be respectively adhered to the top and bottom surfaces of the hydrophobic porous layer. The upper and lower substrates may be fixed to each other by the hydrophobic porous layer to form a microfluidic structure, such as a chamber or a channel.

The microfluidic device produced according to the flowchart of FIG. 10 may be one of the microfluidic devices of the exemplary embodiments described with reference to FIGS. 3 through 8.

According to the microfluidic device according to the above-described exemplary embodiments, the air within the microfluidic structure may be exhausted without a vent so that a sample or a reagent can move smoothly. Since the vent is not formed in a small area in the microfluidic device, the limitations in degree of freedom for design and the risk of leaking residues may be avoided.

As is apparent from the above description, in a microfluidic device according to one exemplary aspect, the air within a microfluidic structure can be exhausted without forming a vent so that a fluid can move smoothly. A limitation in degree of freedom for design and the risk of leaking residues due to formation of a vent in a small area can be avoided.

Although a few exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A microfluidic device comprising:
an upper substrate and a lower substrate fixed to each other to form a microfluidic structure; and
a hydrophobic porous layer disposed between the upper substrate and the lower substrate and configured to fix the upper and lower substrates and absorb air contained in the microfluidic structure.

2. The microfluidic device according to claim 1, wherein the hydrophobic porous layer comprises:
a hydrophobic porous membrane;
an upper adhesive layer disposed on a top surface of the hydrophobic porous membrane and configured to adhere the hydrophobic porous membrane to the upper substrate; and
a lower adhesive layer disposed on a bottom surface of the hydrophobic porous membrane and configured to adhere the hydrophobic porous membrane to the lower substrate.

3. The microfluidic device according to claim 1, wherein the hydrophobic porous layer is a hydrophobic porous adhesive layer.

4. The microfluidic device according to claim 2, wherein the hydrophobic porous membrane is a hydrophobic-processed porous membrane.

5. The microfluidic device according to claim 3, wherein the hydrophobic porous adhesive layer includes a hydrophobic-processed porous adhesive.

6. The microfluidic device according to claim 3, wherein the hydrophobic porous adhesive layer is a foam tape.

7. The microfluidic device according to claim 4, wherein the porous membrane includes at least one selected from the group consisting of polycarbonate (PC), polyether sulfone (PES), polyethylene (PE), polysulfone (PS), polyaryl sulfone (PASF), polyethylene naphthalate (PEN), polyimide (PI), and cellulose acetate (CA).

8. The microfluidic device according to claim 2, wherein the porous membrane has a pore size of about 0.3 μm to about 50 μm.

9. The microfluidic device according to claim 4, wherein the porous membrane is coated with a silicon (Si)-based, fluorine (F)-based, or Si—F compound-based oligomer or polymer.

10. The microfluidic device according to claim 2, wherein the hydrophobic porous membrane has a contact angle of about 90° to about 170°.

11. A method of producing a microfluidic device comprising:
preparing an upper substrate and a lower substrate;
preparing a hydrophobic porous layer; and
fixing the upper substrate and the lower substrate via the hydrophobic porous layer to form a microfluidic structure, wherein the hydrophobic porous layer is configured to absorb air contained in the microfluidic structure.

12. The method according to claim 11, wherein the hydrophobic porous layer comprises:
a hydrophobic porous membrane;
an upper adhesive layer disposed on a top surface of the hydrophobic porous membrane and configured to adhere the hydrophobic porous membrane to the upper substrate; and
a lower adhesive layer disposed on a bottom surface of the hydrophobic porous membrane and configured to adhere the hydrophobic porous membrane to the lower substrate.

13. The method according to claim 11, wherein the hydrophobic porous layer is a hydrophobic porous adhesive layer.

14. The method according to claim 12, wherein the preparing the hydrophobic porous layer includes subjecting the porous membrane to hydrophobic processing.

15. The method according to claim 13, wherein the preparing the hydrophobic porous layer includes subjecting the porous adhesive layer to hydrophobic processing.

16. The method according to claim 13, wherein the hydrophobic porous layer is a foam tape.

17. The method according to claim 11, further comprising engraving an engraving structure corresponding to the microfluidic structure in at least one of the upper substrate and the lower substrate.

18. The method according to claim 11, further comprising removing a portion corresponding to the microfluidic structure from the hydrophobic porous layer.
